(19) United States
(12) Patent Application Publication
(10) Pub. No.: US 2012/0200883 A1
(43) Pub. Date: Aug. 9, 2012

(54) DEVICE MANAGEMENT SYSTEM

(75) Inventor: Daiki Ikari, Ayase-shi (JP)

(73) Assignee: CANON KABUSHIKI KAISHA, Tokyo (JP)

(21) Appl. No.: 13/350,737

(22) Filed: Jan. 13, 2012

(30) Foreign Application Priority Data
Feb. 8, 2011 (JP) 2011-025340

(51) Int. Cl. G06F 3/12

(52) U.S. Cl. 358/1.15

(57) ABSTRACT

Disclosed is a system in which a device which can measure a power consumption amount and a management apparatus which manages the device are connected to a network. In the device, a power consumption amount of the device is obtained by a power meter, and whether or not the power consumption amount of the device was normally measured is determined. The device notifies the management apparatus of information which associates at least the obtained power consumption amount with the determination result. In the management apparatus, the notification from the device is received, and the power consumption amount of the device is estimated and corrected with reference to the received determination result.

### BACKGROUND OF THE INVENTION

1. Field of the Invention

The present invention relates to a device management system which can calculate or measure a power consumption amount of a device.

2. Description of the Related Art

In recent years, in order to reduce emission amounts of greenhouse effect gases such as carbon dioxide, it has come to be required to reduce the amount of power consumed by the use of devices such as printers and MFPs. For this reason, it has come to be required to allow the user to recognize power consumption amounts (so-called “visualization”) when such devices are used. For example, Japanese Patent Laid-Open No. 2003-335026 discloses a technique in which, in a system configured by connecting a plurality of copying machines (image forming apparatuses) that can measure power consumptions, and a management apparatus for these copying machines to a network, the respective copying machines output data associated with measured power consumption amounts in response to a request of the management apparatus. With this technique, for example, the management apparatus can uniformly manage monthly logs of power consumption amounts of the respective copying machines. Also, Japanese Patent Laid-Open No. 2010-072870 discloses a technique in which, in a system configured by connecting a plurality of devices and a power consumption amount calculation apparatus to a network, the power consumption amount calculation apparatus receives power consumption information from a device which can measure a power consumption, and applies the received information to calculations (estimations) of power consumption amounts of other devices.

However, in the system described in Japanese Patent Laid-Open No. 2003-335026 or 2010-072870, when a power consumption measurement unit of a device that can measure a power consumption breaks down, information of power consumption amounts cannot be appropriately managed. More specifically, power consumption amounts cannot be normally obtained until a repair of the power consumption measurement unit by means of component replacement or maintenance is completed. Likewise, when the power consumption measurement unit is detachable, and is unexpectedly detached, power consumption amounts cannot be normally obtained. They pose serious problems for the system which manages information of power consumption amounts in detail, and widely uses such information.

### SUMMARY OF THE INVENTION

An aspect of the present invention is to eliminate the above-mentioned problems with the conventional technology. The present invention provides a mechanism that allows to manage power consumption amounts more appropriately even when a device cannot normally obtain a power consumption amount.

The present invention provides a system for obtaining a power consumption amount of a device and managing the obtained power consumption amount, the system comprising: an obtaining unit configured to obtain a power consumption amount of the device by a power meter; an estimation unit configured to estimate the power consumption amount of the device based on a executed job log; and a management unit configured to, when the obtaining unit normally obtains the power consumption amount of the device, manage the obtained consumption amount of device, and when the obtaining unit does not normally obtain the power consumption amount of the device, manage the power consumption amount estimated by the estimation unit.

According to the present invention, even when a device cannot normally obtain a power consumption amount, the power consumption amounts can be managed more appropriately.

Further features of the present invention will become apparent from the following description of exemplary embodiments with reference to the attached drawings.

### BRIEF DESCRIPTION OF THE DRAWINGS

FIG. 1 is a block diagram showing the configuration of a device management system according to the first embodiment of the present invention;

FIG. 2 is a block diagram showing the arrangement of an image forming apparatus;

FIG. 3 is a view showing an operation unit of the image forming apparatus;

FIG. 4 is a block diagram showing a power measurement unit in the image forming apparatus;

FIG. 5 is a flowchart showing the measurement operation sequence of a power consumption amount;

FIG. 6 is a diagram showing a power consumption amount management program in the image forming apparatus;

FIGS. 7A and 7B show operation log information tables;

FIG. 8 is a flowchart showing the generation sequence of operation log information of the image forming apparatus;

FIG. 9 is a block diagram showing the arrangement of a power consumption management server;

FIG. 10 is a block diagram showing the functional arrangement of the power consumption amount management program;

FIGS. 11A, 11B, 11C, and 11D are tables showing device configuration information;

FIG. 12 is a view showing a display example of power consumption amounts;

FIG. 13 is a flowchart showing the operation log information collection sequence;

FIG. 14 is a flowchart showing the power consumption amount estimation processing sequence;

FIG. 15 is a flowchart showing the estimated power consumption amount update sequence;

FIGS. 16A and 16B are views showing display change examples of power consumption amounts; and

FIG. 17 is a block diagram showing a power consumption amount management program in an image forming apparatus according to the second embodiment of the present invention.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. The same reference numerals denote the same components, and a repetitive description thereof will be avoided.

### First Embodiment

<System Arrangement>

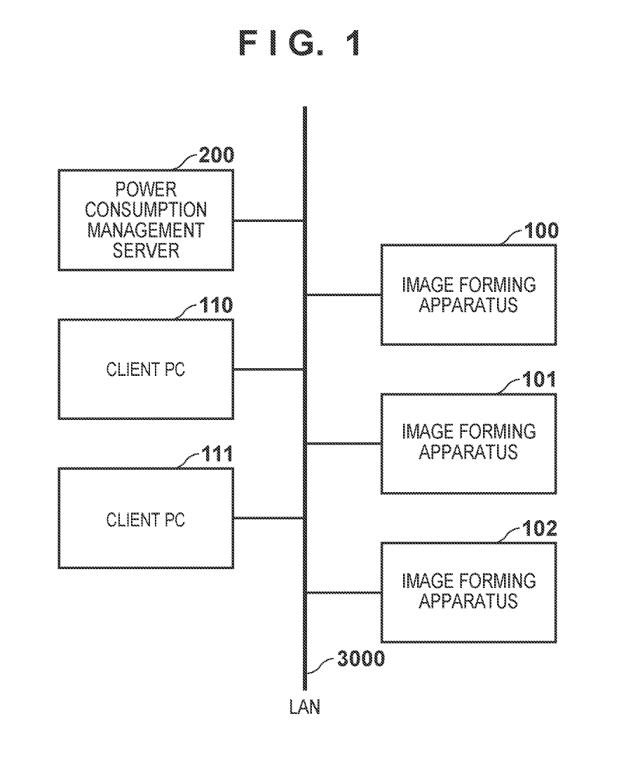

FIG. 1 shows the overall configuration of a device management system which mainly manages information associated with power consumptions of respective image forming apparatuses according to this embodiment. This system includes image forming apparatuses 100, 101, and 102 such as a printer, MFP, and FAX machine, client PCs 110 and 111 which can transmit print data to these image forming apparatuses, and a power consumption management server 200.

The power consumption management server 200 manages power consumption amounts in network devices such as these image forming apparatuses 100, 101, and 102. The client PCs 110 and 111, image forming apparatuses 100, 101, and 102, and power consumption management server 200 are connected via a LAN 3000 to be able to communicate with each other.

The power consumption management server 200 receives information which records operation logs (to be referred to as operation log information hereinafter) from each of the image forming apparatuses 100, 101, and 102. The operation log information records information associated with operation executions of the image forming apparatus (for example, information which allows to discriminate by whom, when, and with what settings the image forming apparatus was used). For example, when the image forming apparatus 100 executes a print instruction received from the client PC 110 shown in FIG. 1, log information including a job type, the number of printed pages, a single/double-sided setting type, a paper size, and the like is recorded. The operation log information is appended with information associated with an electric energy consumed upon execution of the operation by the image forming apparatus in this embodiment.

As described above, the power consumption management server 200 is configured to assume a role as a server for managing power consumptions of devices on a network by managing the received operation log information and power consumption amount information appended to that information.

<Overall Arrangement of Image Forming Apparatus>

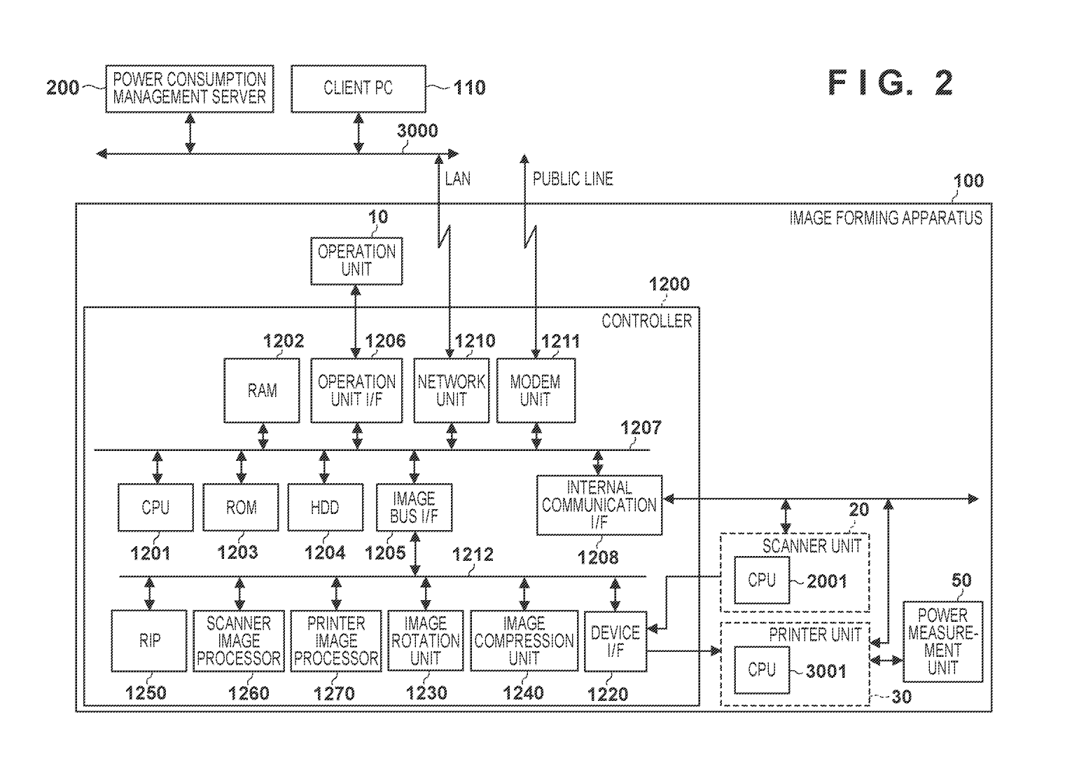

FIG. 2 is a block diagram showing an example of the arrangement of the image forming apparatus 100 which can calculate a power consumption amount by measuring a power consumption according to the present invention. The arrangement of one forming apparatus 100 will be described below, and the remaining image forming apparatuses 101 and 102 have the same arrangement.

The image forming apparatus 100 includes an operation unit 10, scanner unit 20, printer unit 30, power measurement unit 50, and controller 1200. The operation unit 10 allows the user who uses the image forming apparatus 100 to make various operations.

The scanner unit 20 scans image information in accordance with an instruction from the operation unit 10. The scanner unit 20 has a CPU 2001 which controls the scanner unit 20, and an illumination lamp, scanning mirror, and the like (not shown) required to scan a document.

The printer unit 30 prints an image according to image data on a sheet. The printer unit 30 includes a CPU 3001 which controls the printer unit, and a photosensitive drum, fixing device, and the like (not shown) required to form and fix an image.

The power measurement unit 50 measures a power consumption in the image forming apparatus 100. The controller 1200 systematically controls the operation of the image forming apparatus 100. The controller 1200 is connected to the scanner unit 20, the printer unit 30, the LAN 3000, and a public line (WAN). The controller 1200 executes input/output control of image information, device information, information associated with power consumption amounts, and the like.

<Detailed Internal Arrangement of Controller>

The internal arrangement of the controller 1200 will be described in detail below with reference to FIG. 2. The controller 1200 includes a CPU 1201, RAM 1202, ROM 1203, hard disk drive (HDD) 1204, operation unit I/F 1206, network unit 1210, modem unit 1211, internal communication I/F 1208, and image bus I/F 1205. These units are connected to each other via a system bus 1207 to be able to communicate with each other.

The CPU 1201 functions as a control unit which systematically controls the image forming apparatus 100. The RAM 1202 functions as a system work memory required for the CPU 1201 to operate, and also as an image memory required to temporarily store image data.

The ROM 1203 stores a boot program executed by the CPU 1201. The HDD 1204 stores system software, image data, a software counter value, and the like.

The operation unit I/F 1206 is an interface with the operation unit 10, and outputs image data to be displayed on the operation unit 10 to the operation unit 10. The operation unit I/F 1206 assumes a role of transferring, to the CPU 1201, information which is input by the user who uses the image forming apparatus 100 from the operation unit 10.

The network unit 1210 is connected to the LAN 3000, and communicates (exchanges information) with the power consumption management server 200, client PC 110, and other computer terminals (not shown).

The modem unit 1211 is connected to the public line, and makes data communications (transmission/reception) with an external FAX apparatus (not shown). The internal communication I/F 1208 respectively communicates with the scanner unit 20 and printer unit 30. The image bus I/F 1205 functions as a bus bridge which connects the system bus 1207 and an image bus 1212 to convert data structures.

Furthermore, the controller 1200 includes a raster image processor (RIP) 1250, scanner image processor 1260, printer image processor 1270, image rotation unit 1230, image compression unit 1240, and device I/F 1220. The units are connected to each other via the image bus 1212 to be able to communicate with each other.

The RIP 1250 rasterizes PDL code data included in a print job received from the client PC 110 on the LAN via the LAN 3000 into bitmap image data. The scanner image processor 1260 corrects, modifies, and edits image data input from the scanner unit 20.

The printer image processor 1270 executes correction, resolution conversion, and the like for image data to be output (printed) by the printer unit 30. The image rotation unit 1230 rotates image data. The image compression unit 1240 applies compression/decompression processing to multi-valued image data by JPEG or to binary image data by JBIG, MMR, or MH.

The scanner unit 20 and printer unit 30 are connected to the device I/F 1220, which converts synchronous/asynchronous systems of image data.

<Detailed Arrangement of Operation Unit>

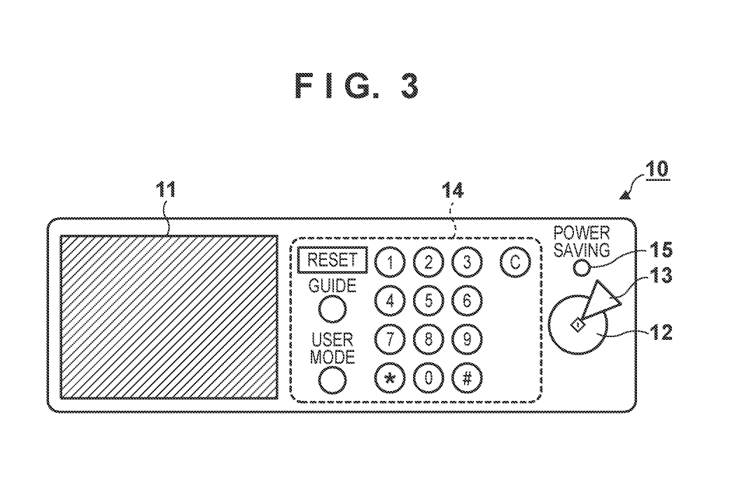

FIG. 3 shows an example of the arrangement of the operation unit 10. A liquid crystal operation panel 11 is a touch panel as a combination of a liquid crystal display and input device, displays an operation screen, and sends information of a display key pressed by the user to the controller 1200.

A start key 12 is used to start a scanning/printing operation of a document image, and to issue start instructions of other functions. In the start key, LEDs of two colors, that is, green and red LEDs are embedded; when the green LED is ON, it indicates that the apparatus is ready to start; when the red LED is ON, it indicates that the apparatus is not ready to start.

A stop key 13 serves to stop an active operation. A hardware key group 14 includes a numerical key pad, clear key, reset key, guide key, and user mode key. A power saving key 15 is used when the image forming apparatus is controlled from the operation unit 10 to transit to or return from a sleep mode.

When the user presses the power saving key 15 in a normal mode, the image forming apparatus transits to the sleep mode; when he or she presses the power saving key 15 in the sleep mode, the image forming apparatus transits to the normal mode.

The operation unit 10 transmits information required to generate operation information such as a user name, the number of printed/copied pages, and output attribute information, which are input by the user using the liquid crystal operation panel 11, to the operation unit I/F 1206.

<Execution of Print Job>

The image forming apparatus 100 shown in FIG. 2 executes print processing as follows based on a print job transmitted from the client PC 110 connected to the LAN 3000. The CPU 1201 stores print data as image data received from the client PC 110 connected to the LAN 3000 via the network unit 1210 in the RAM 1202. Then, the CPU 1201 supplies this image data to the RIP 1250 via the image bus I/F 1205, the RIP 1250 rasterizes this image data (PDL code data) into bitmap data, and the image compression unit 1240 executes compression processing of the bitmap data and stores the compressed data in the HDD 1204.

Next, the image data (compressed bitmap data) stored in the HDD 1204 is supplied to the image compression unit 1240 via the image bus I/F 1205. The image compression unit 1240 decompresses the supplied image data (compressed bitmap data), the printer image processor 1270 executes correction for the printer, resolution conversion, and the like, and the image rotation unit 1230 applies rotation processing to the image data as needed. The image which has undergone various kinds of processing is output to the printer unit 30 as print data via the device I/F 1220, and the printer unit 30 executes print processing on a sheet.

As will be described in detail later, even during execution of the aforementioned print job, the printer unit 30 obtains measurement values of the power measurement unit 50 at given time intervals to calculate a power consumption amount, and is ready to transmit the power consumption amount in response to a request from the controller 1200.

<Arrangement of Power Measurement Unit of Image Forming Apparatus>

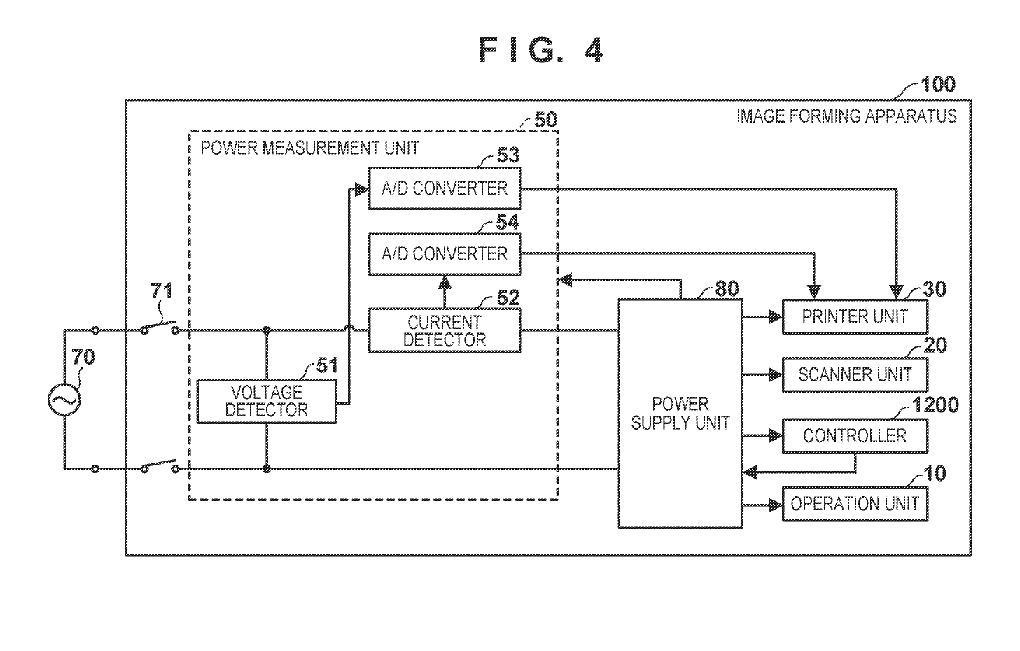

FIG. 4 shows an example of the power supply arrangement and the internal arrangement in the power measurement unit 50 in the image forming apparatus 100. Referring to FIG. 4, a commercial power supply 70 is connected to a power supply unit 80 via a main power switch 71 and the power measurement unit 50.

The power supply unit 80 internally generates power supplies required for respective units of the image forming apparatus 100 such as the scanner unit 20, printer unit 30, power measurement unit 50, controller 1200, and operation unit 10 based on the commercial power supply 70, and supplies them to these units.

The power measurement unit 50 includes a voltage detector 51 which detects a voltage, and a current detector 52 which detects a current. As a practical voltage detection method, L (line) and N (neutral) of a general commercial power supply may be full-wave rectified, may be converted into lower voltages using a transformer and the like, and may be read by an A/D converter 53. As a practical current detection method, a current value flowing through L (line) may be converted into a magnetic flux, which may then be converted into a voltage, and the voltage may be read by an A/D converter 54, or may be read by inserting a current value detection resistor. Also, as another method, an element whose temperature changes depending on a flowing current may be inserted to read a current value.

A voltage level and current level, which are detected by the aforementioned methods and are A/D-converted, are input to the printer unit 30 in this embodiment, and a power consumption amount is calculated in the printer unit 30. As another method, the power measurement unit 50 may include a DSP (Digital Signal Processor) which executes fast calculation processing of digital data to calculate a power consumption amount in the power measurement unit 50. In this case, the power measurement unit 50 may be directly connected to the controller 1200 via the internal communication I/F 1208.

<Power Consumption Amount Calculation Processing of Printer Unit>

The voltage level and current level, which are input to the printer unit 30, as described above, are read by the CPU 3001 of the printer unit 30, and a result obtained by multiplying the two values is held in the printer unit 30 as a power consumption. Based on an elapsed time period from an immediately preceding read timing, the power consumption is multiplied by the time period, thereby calculating a power consumption amount within the predetermined time period. The power consumption amount calculated inside the printer unit 30 based on this measurement result can be transmitted to the CPU 1201 of the controller 1200 when the printer unit 30 communicates with the internal communication I/F 1208 in the controller 1200.

Especially, a power consumption amount within the predetermined time period, which is calculated inside the printer unit 30, is accumulated and held for a plurality of times, and when a power measurement value request is received from the controller 1200 via the internal communication I/F 1208, the accumulated and held contents are notified, and the internal accumulated and held contents are cleared. In this way, the controller 1200 can be efficiently notified of the power consumption amount within an interval between neighboring requests from the controller 1200.

Assume that a calculation interval of a power consumption amount in the printer unit 30, in other words, a read interval of output values of the power measurement unit 50 by the printer unit 30 can be freely set within a range free from any influences on the aforementioned print job and other print processes.

<Electric energy Calculation Sequence of Printer Unit>

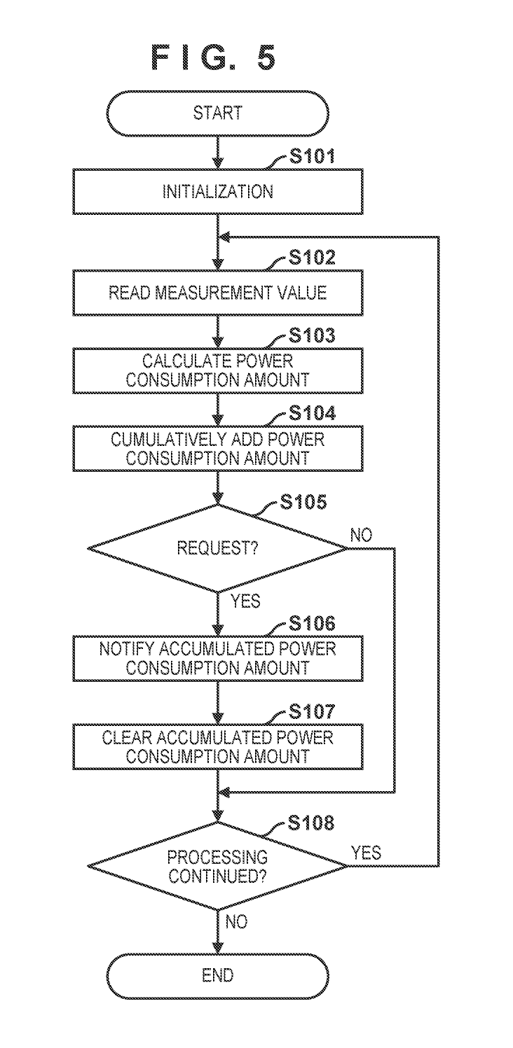

FIG. 5 is a flowchart showing the operations associated with calculations of the power consumption amount of the image forming apparatus 100, which operations are executed by the CPU 3001 of the printer unit 30.

In step S101, the CPU 3001 executes initialization processing. More specifically, the CPU 3001 initializes internally held data (an accumulated power consumption amount, etc.) associated with the power consumption amount. In step S102, the CPU 3001 reads measurement values. The measurement values include values of the voltage level and current level, which are read by the power measurement unit 50 and are A/D-converted.

In step S103, the CPU 3001 calculates a power consumption amount. More specifically, the CPU 3001 calculates a power consumption amount using the measurement values read in step S102 and an elapsed time period since the previous read timing of the measurement values. That is, the CPU 3001 executes processing for multiplying the voltage level and current level of the measurement values to calculate a power consumption, and then multiplying it by the elapsed time period, thereby calculating a power consumption amount.

In step S104, the CPU 3001 cumulatively adds the power consumption amount calculated in step S103, and internally holds the result. More specifically, the CPU 3001 executes processing for adding the currently calculated power consumption amount to the previously calculated power consumption amount. By repeating this processing, the power consumption amount of the accumulated elapsed time period can be held as information.

The CPU 3001 checks in step S105 whether or not a notification request of the accumulated power consumption amount internally held in step S104 is detected. In this case, a request source is the CPU 1201 of the controller 1200, and the request is sent via the internal communication I/F 1208. If the request is detected, the process advances to step S106; otherwise, the process jumps to step S108.

Then, in step S106, the CPU 3001 returns a response to the notification request from the CPU 1201 of the controller 1200 in step S105. More specifically, the CPU 3001 notifies the request source of the internally and cumulatively held power consumption amount via the internal communication I/F 1208. Then, the CPU 1201 of the controller 1200 can obtain information of the power consumption amount until it issued the request.

In step S107, the CPU 3001 executes clearing processing of the internally and cumulatively held power consumption amount. This clearing processing is executed to begin to accumulate new power consumption amounts since the CPU 3001 has notified the controller 1200 of the accumulated power consumption amount in step S106.

The CPU 3001 checks in step S108 whether or not to continue the processing. If the processing is to be continued, the process returns to step S102 to continuously execute the electric energy calculation sequence; otherwise, the electric energy calculation sequence ends.

<Operation Management Control of Power Consumption Amount Management Control>

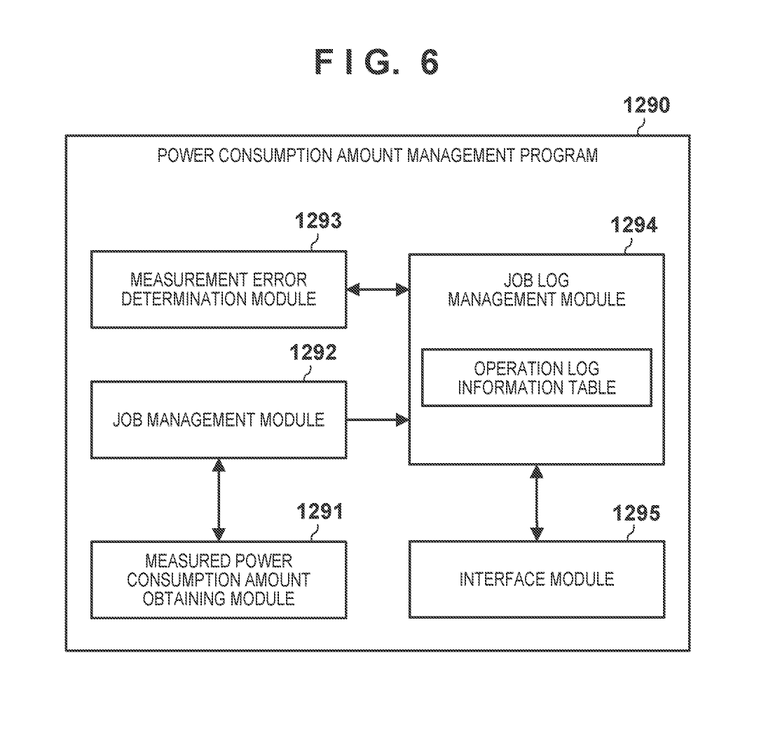

FIG. 6 shows an example of a power consumption amount management program 1290 executed by the image forming apparatus 100. This program is stored in the HDD 1204 together with job control programs required to execute a print job, copy job, and the like. These programs are loaded from the HDD 1204 onto the RAM 1202 when the CPU 1201 executes the boot program. Then, corresponding processes are implemented when the CPU 1201 executes the programs loaded on the RAM 1202.

In the power consumption amount management program 1290 shown in FIG. 6, a measured power consumption amount obtaining module 1291 sends a request of an internally held calculated power consumption amount to the printer unit 30 and receives a response via the internal communication I/F 1208, thus obtaining a power consumption amount. When the measured power consumption amount obtaining module 1291 issues a power consumption amount request at the end timing of a job to the printer unit 30 via the internal communication I/F 1208, it can obtain a power consumption amount of that job. When the measured power consumption amount obtaining module 1291 issues a power consumption amount request at the start timing of the subsequent job, it can obtain a power consumption amount between the jobs.

A measurement error determination module 1293 determines based on the obtained power consumption amount whether or not the power measurement unit 50 normally measured a power consumption. The measurement error determination may be configured to, for example, compare each measurement value with a certain threshold, and to judge a measurement error if the measurement value is equal to or smaller than (or equal to or larger than) the threshold.

In this embodiment, when the obtained power consumption amount is 0 W, a failure is determined, but a failure determination criterion may be freely set. In this embodiment, the measurement error determination module 1293 is described as a program. Alternatively, a measurement error determination circuit which detects component failures and the like may be implemented as hardware. As causes of measurement errors, a failure of the power measurement unit 50 is assumed. In addition, when the power measurement unit 50 is detachable, a measurement error occurs when the power measurement unit 50 is unexpectedly detached.

A job management module 1292 analyzes a print or copy job to obtain a user name, the number of printed pages, output attribute information such as color printing, a power consumption amount, and the like, and manages them as operation information. The operation information is obtained from the operation unit I/F 1206 if a job of interest (for example, a copy job) is issued from the operation unit 10. Also, the operation information is obtained from the network unit 1210 if a job of interest (for example, a print job) is issued from the client PC 110 or another terminal.

The job management module 1292 obtains a power consumption amount during job processing using the measured power consumption amount obtaining module 1291 when it manages the operation information. Furthermore, the job management module 1292 can also obtain a power consumption amount between jobs. When the power consumption amount between the jobs is obtained, the job management module 1292 manages it in the same format as the operation information of a job together with an operation state (standby or sleep state) during that interval, thereby efficiently managing the operation information. Likewise, the job management module 1292 checks, using the measurement error determination module 1293, whether or not the obtained power consumption amount is normal (whether or not a measurement error has occurred), when it manages the operation information, and links this checking result with the operation information. The job management module 1292 transmits the operation information managed in this way to a job log management module 1294.

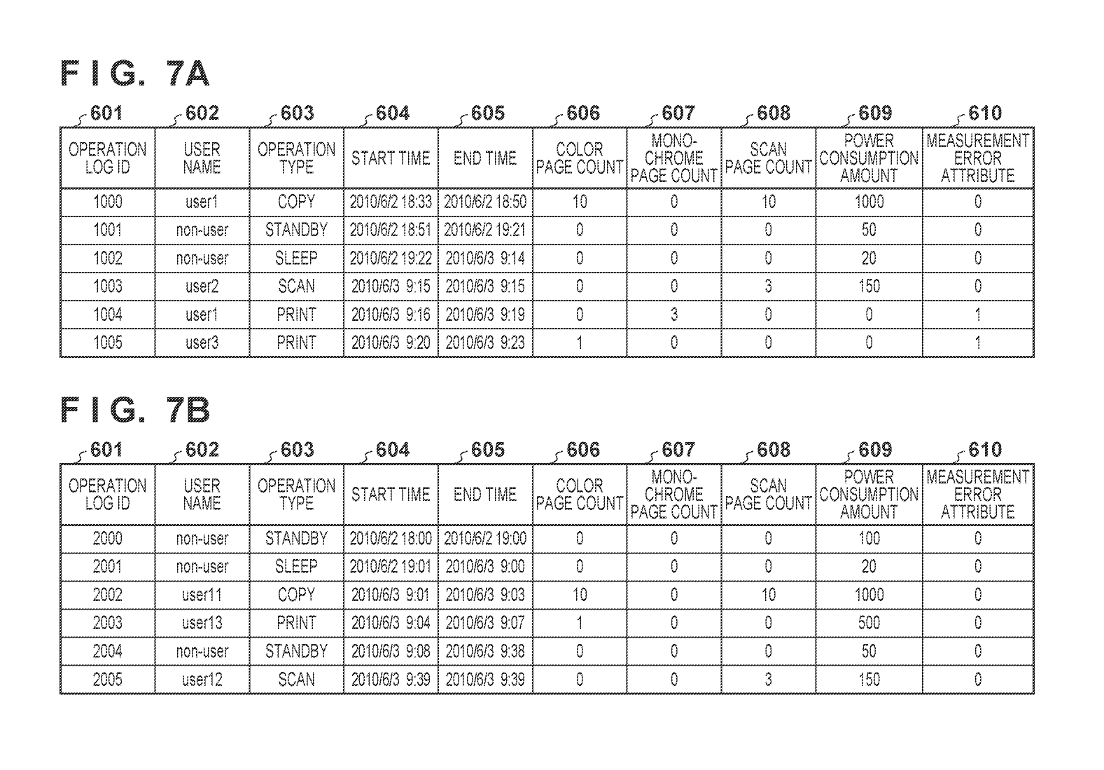

The job log management module 1294 holds the operation information received from the job management module 1292 at a given timing (for example, a job start or end timing) as an operation log information table. FIGS. 7A and 7B show examples of operation log information tables held by the job log management module 1294. FIG. 7A shows an example of an operation log information table of the image forming apparatus 100, and FIG. 7B shows an example of an operation log information table of the image forming apparatus 101. Assume that the power consumption management server 200 combines these tables and collectively manages them as individual tables.

An operation log ID 601 in FIG. 7A is used to uniquely identify an operation log of a job or the like. However, as described above, operation states (standby are sleep states) which are not a job are efficiently and collectively managed. A user name 602 indicates a name of a user who instructed execution of a job. However, for a non-job operation state, “non-user” is displayed.

An operation type 603 indicates a type of an executed job, an operation state, or the like, and includes a print job, copy job, scan job, and the like from the client PC 110 and also operation states such as a standby state and sleep state. A start time 604 and end time 605 indicate those of an operation state (including a job). A color page count 606 indicates the number of color-printed/copied pages by a corresponding job. A monochrome page count 607 indicates the number of monochrome-printed/copied pages by a corresponding job.

A scan page count 608 indicates the number of pages scanned by the scanner unit 20, and the number of color-scanned pages, the number of monochrome-scanned pages, and the like can be distinctly recorded. A power consumption amount 609 indicates an electric energy (Wh) consumed by a corresponding operation. Furthermore, electric energies consumed by standby and sleep states are also recorded.

A measurement error attribute 610 indicates a checking result as to whether or not an electric energy consumed by a corresponding operation can be normally obtained. Based on these pieces of information, job log information indicating a user, a type, start and end times, and a power consumption amount of a job is recorded.

For example, an operation log ID “1000” indicates execution of a copy job, which started at 2010 Jun. 2_{—}18:33 and ended at 2010 Jun. 2_{—}18:50. Furthermore, this operation log ID indicates that in this job, 10 pages were scanned, 10 pages were color-printed, and an electric energy of 1,000 Wh was consumed.

The operation log information tables may be configured to be created for respective job types. This operation log information table also manages whether or not a power consumption amount is normally obtained. Taking FIG. 7A as an example, in operation log IDs “1000” to “1003”, power consumption amounts were normally obtained, but in operation log IDs “1004” and “1005”, a power consumption amount was 0 W, and the measurement error determination module 1293 determined measurement errors. Hence, in these IDs, a measurement error attribute=1.

An interface module 1295 displays the operation log information tables as pieces of operation information held by the job log management module 1294 on the liquid crystal operation panel 11 of the operation unit 10. Also, the interface module 1295 controls to output these tables to the client PC 110 and other external apparatuses connected on the LAN 3000 via the network unit 1210.

<Operation Log Information Generation Sequence of Controller>

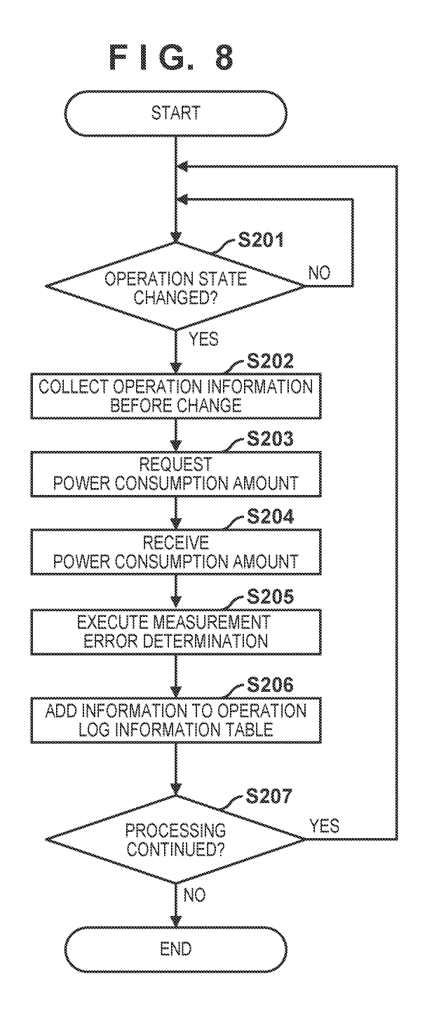

FIG. 8 is a flowchart showing the operations associated with generation of operation log information of the image forming apparatus 100, which operations are executed by the CPU 1201 of the controller 1200.

The CPU 1201 checks in step S201 whether or not an operation state has changed. More specifically, the CPU 1201 monitors if the operation state of the image forming apparatus 100 has changed from a standby state to a sleep state or vice versa, if the operation state has transited to execution of a received job in response to job reception, if the executed job ended, and the operation state has changed to a standby state since the executed job ended, and so forth, thus obtaining the checking result. If the operation state has not changed in step S201, the CPU 1201 continuously checks in step S201 whether or not the operation state has changed. If the operation state has changed in step S201, the process advances to step S202.

In step S202, the CPU 1201 collects information before the change of the operation state changed in step S201. When the operation state before the change is a standby or sleep state, the CPU 1201 obtains duration information indicating how many hours that state continued. On the other hand, when the operation state before the change is job execution, the CPU 1201 obtains information associated with job execution. Note that this processing is executed by the CPU 1201 using the function of the job management module 1292 in the aforementioned power consumption amount management program 1290.

Then, in step S203, the CPU 1201 issues a request of the internally held calculated power consumption amount to the CPU 3001 of the printer unit 30 via the internal communication I/F 1208. This processing is executed by the CPU 1201 using the function of the measured power consumption amount obtaining module 1291 in the power consumption amount management program 1290.

In step S204, the CPU 1201 receives the power consumption amount from the CPU 3001 of the printer unit 30 via the internal communication I/F 1208, and holds it together with information of the operation state using the function of the job management module 1292.

The CPU 1201 then checks in step S205 based on the received power consumption amount whether or not the power measurement unit 50 normally measured a power consumption. This processing is executed using the function of the measurement error determination module 1293 in the aforementioned power consumption amount management program 1290, and the checking result is appended to the information of the operation state.

In step S206, the CPU 1201 generates an operation log information table or adds information to the operation log information table using the pieces of information obtained in steps S202 to S205. More specifically, the CPU 1201 generates an operation log information table shown in FIGS. 7A and 7B using the function of the job log management module 1294 in the aforementioned power consumption amount management program 1290, and adds information to that table when new operation state information is generated.

Then, the CPU 1201 checks in step S207 whether or not to continue the processing. If the processing is to be continued, the process returns to step S201 to continuously execute the operation log information generation sequence; otherwise, the operation log information generation sequence ends.

<Hardware Arrangement of Power Consumption Management Server>

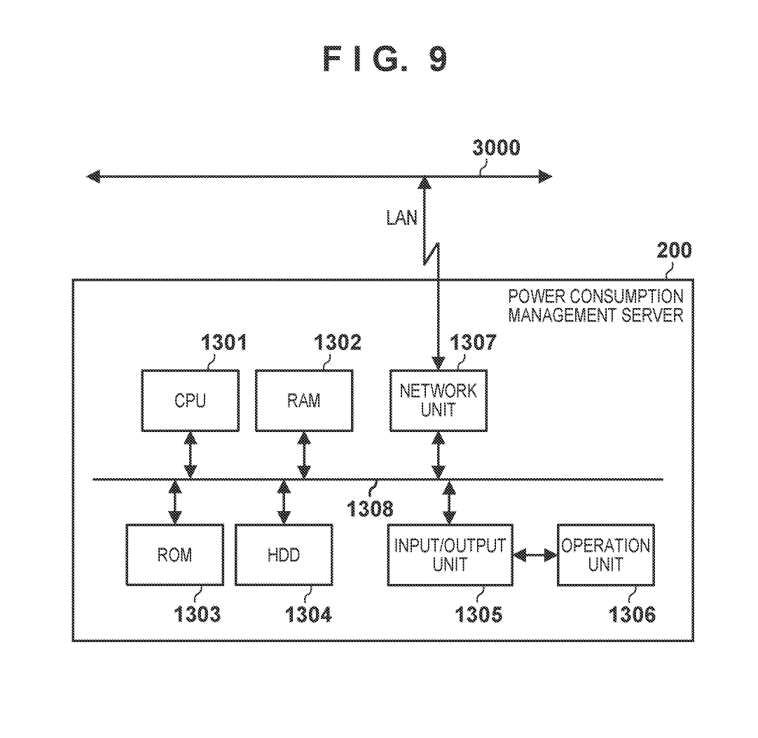

FIG. 9 shows an example of the hardware arrangement of the power consumption management server 200. The power consumption management server 200 has a CPU 1301, RAM 1302, ROM 1303, HDD 1304, network unit 1307, input/output unit 1305, and operation unit 1306. These units are connected to each other via a system bus 1308.

The CPU 1301 provides various functions by reading out programs such as an OS (Operating System) and application software from the HDD 1304, and executing them. The CPU 1301 systematically controls power consumption management processing executed by the power consumption management server 200.

The RAM 1302 is a system work memory used when the CPU 1301 executes programs. The ROM 1303 stores a BIOS (Basic Input Output System), a program required to launch the OS, and setting files.

The HDD 1304 is a hard disk drive, which stores system software and programs required to implement respective means to be described later. These programs are installed in the HDD 1304 when they are delivered while being stored in storage media or are downloaded from a predetermined server connected via the LAN 3000.

The network unit 1307 is connected to the LAN 3000, and communicates (exchanges information) with external devices such as the client PCs 110 and 111 and the image forming apparatuses 100, 101, and 102. The input/output unit 1305 is an interface which inputs/outputs information with the operation unit 1306 configured by input/output devices such as a liquid crystal display and mouse (not shown). On the liquid crystal display, predetermined information is drawn to have a predetermined resolution, number of colors, and the like based on screen information instructed by a program. For example, a GUI (Graphical User Interface) screen is formed, and various windows, data, and the like required for operations are displayed.

The arrangement of the power consumption management server 200 has been described. Also, the client PCs 110 and 111 have the same hardware arrangement.

<Functional Arrangement of Power Consumption Management Server>

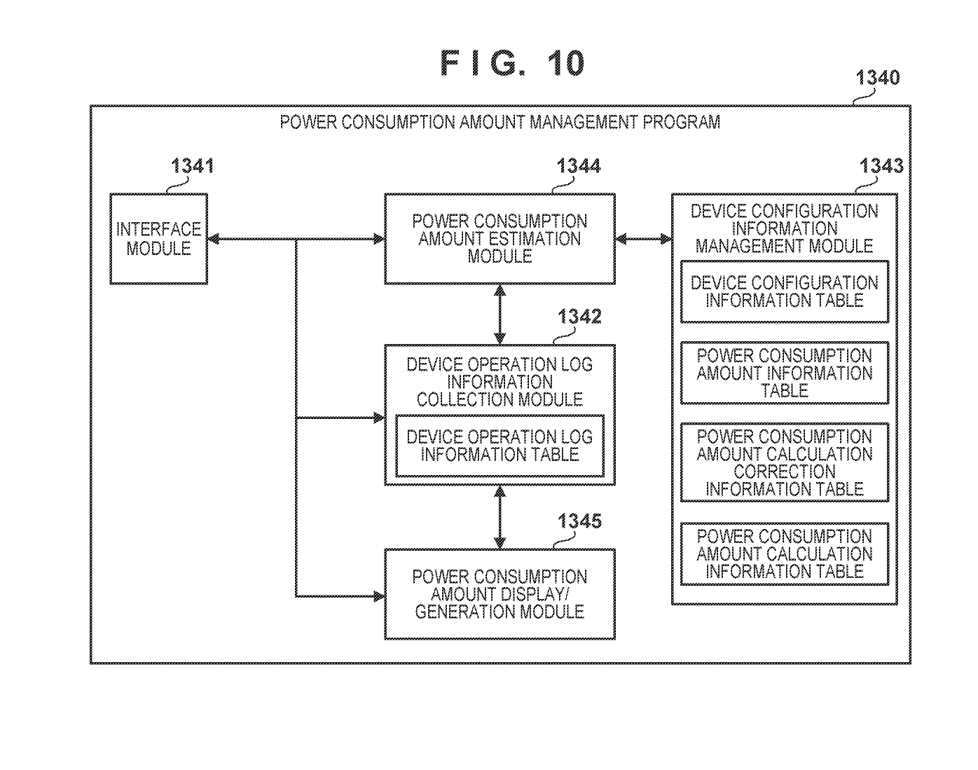

FIG. 10 shows an example of a power consumption management program 1340 executed by the power consumption management server 200. This program is stored in the HDD 1304 as functions to be implemented by this server. This program is loaded from the HDD 1304 onto the RAM 1302 when the CPU 1301 of the power consumption management server 200 executes a boot program. Then, respective processes are implemented when the CPU 1301 executes the program loaded on the RAM 1302.

An interface module 1341 executes control to access external devices such as the client PCs 110 and 111 and the image forming apparatuses 100, 101, and 102 connected on the LAN 3000 via the network unit 1307 shown in FIG. 9 in accordance with instructions from function modules to be described below. Also, the interface module 1341 displays power consumption amount information, which is visualized as a graph or the like by a power consumption amount display/generation module 1345 (to be described later), on a monitor such as the liquid crystal display of the operation unit 1306 via the input/output unit 1305.

A device operation log information collection module 1342 collects and manages pieces of operation log information of devices, which are connected on the network and power consumption amounts of which are to be managed, via the interface module 1341. The devices indicate the image forming apparatuses 100, 101, and 102 in this embodiment. Also, the operation log information indicates the operation log information table shown in FIGS. 7A and 7B. Hence, in the power consumption management server 200, pieces of operation log information including job executions and the like of all the image forming apparatuses are collected and managed.

A device configuration information management module 1343 manages information of types and hardware configurations of respective devices, and information associated with power consumption amounts of respective devices. A power consumption amount described by the device configuration information management module 1343 is an estimated value, which is calculated based on an operation state and device information.

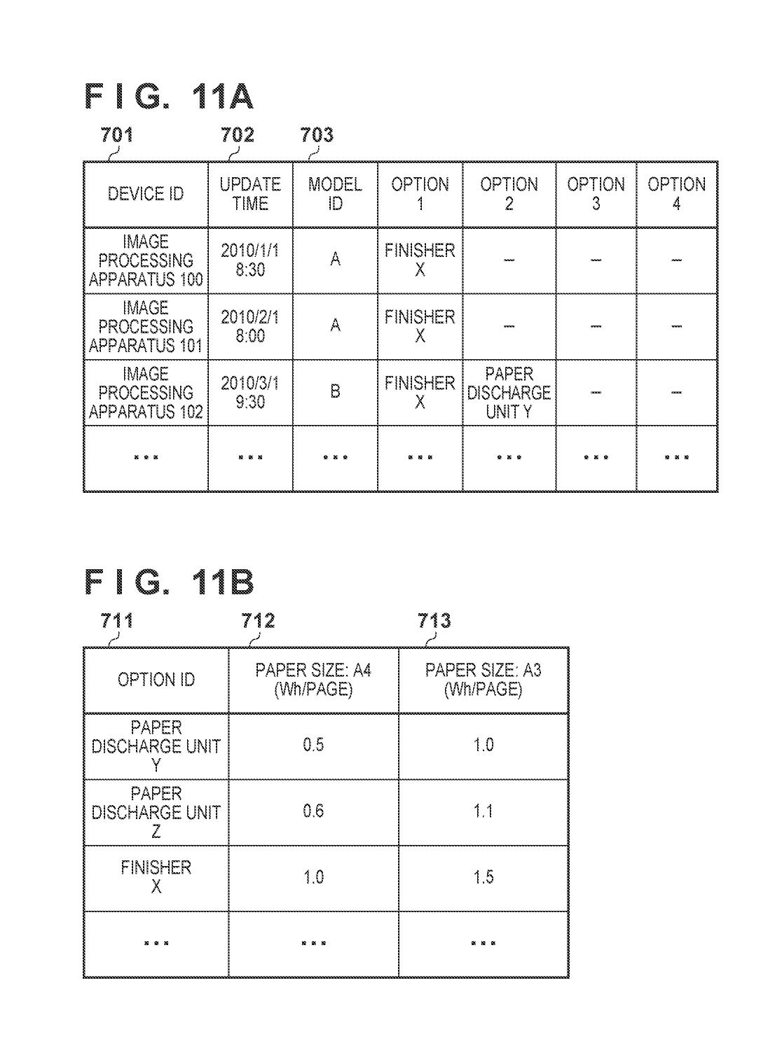

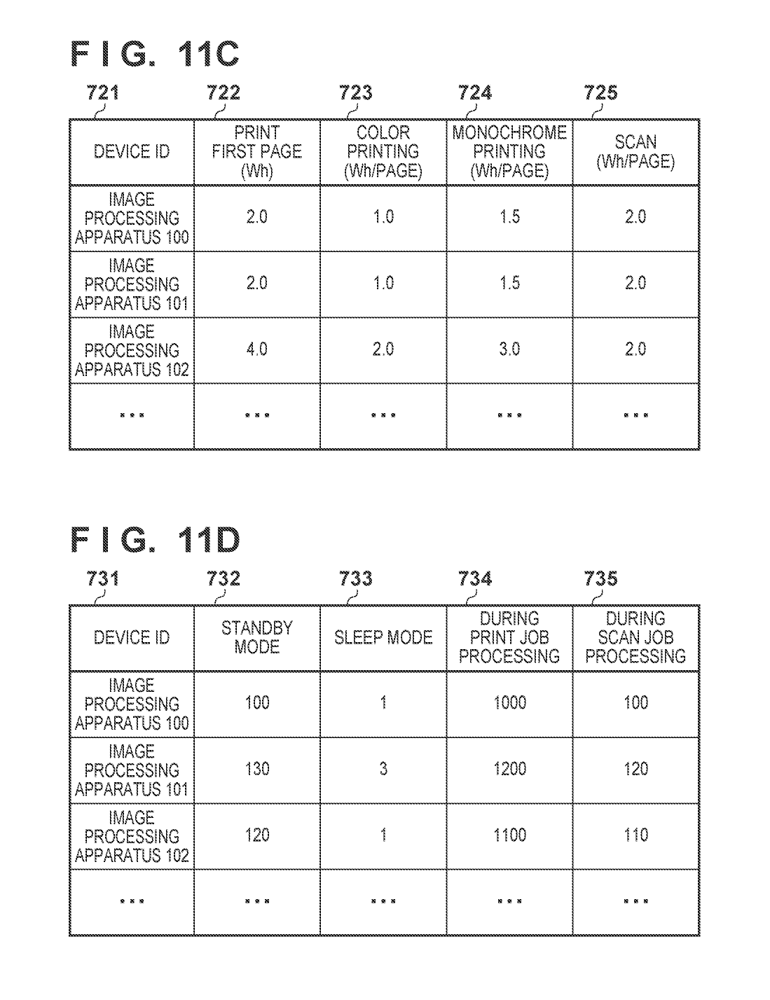

FIG. 11A shows an example of a device configuration information table. A device ID 701 is used to uniquely identify a device to be managed by the power consumption management server 200. As shown in FIG. 11A, in this embodiment, the image forming apparatuses 100, 101, and 102 are managed. An update time 702 indicates a time when the device configuration of each device was changed.

A model ID 703 indicates a type of each device in the device ID 701. The example of the device configuration information table indicates that the image forming apparatuses 100 and 101 are those of the same model having a model ID=A. Also, this example indicates that the image forming apparatus 102 has a model ID=B, and is a model different from the image forming apparatuses 100 and 101.

In options 1 to 4, hardware configuration information actually attached to each device is registered. The example of FIG. 11A indicates that the image forming apparatuses 100 and 101 have configurations in which an optional unit called a finisher X is attached, and the image forming apparatus 102 has a configuration in which the finisher X and a paper discharge unit Z are attached.

The device configuration information management module 1343 also manages information of power consumption amounts of optional units. FIG. 11B shows an example of a power consumption amount information table of optional units. An option ID 711 is used to uniquely identify an optional unit. Power consumption amount 712 denotes power consumption amount information when a paper size is A4. Power consumption amount 713 denotes power consumption amount information when a paper size is A3.

The device configuration information management module 1343 manages power consumption amount calculation correction information associated with a job of each device. FIG. 11C shows an example of a power consumption amount calculation correction information table. A device ID 721 is used to uniquely identify a device to be managed by the power consumption management server 200. Power consumption amount 722 denotes a power consumption amount required to print the first page. Power consumption amount 723 denotes a power consumption amount per page required to execute color printing. Power consumption amount 724 denotes a power consumption amount per page required to execute monochrome printing. Power consumption amount 725 denotes a power consumption amount per page required to execute scanning.

Note that in this embodiment, respective values (power consumption amounts) in the power consumption amount calculation correction information table are those which reflect pieces of information in the aforementioned device configuration information table shown in FIG. 11A and the optional unit power consumption amount information table shown in FIG. 11B. That is, models, optional unit configurations, and increments of power consumption amounts due to the optional unit configurations are obtained from FIGS. 11A and 11B to calculate values in FIG. 11C. For example, numerical values in the fields 722 to 725 of the image forming apparatus 102 in FIG. 11C assume values obtained by taking values of power consumption amounts of the finisher X and paper discharge unit Z on those of operation units related to these optional units with reference to the power consumption amount of the model B. In this way, appropriate power consumption amount calculation correction information is calculated for each device.

The device configuration information management module 1343 also manages power consumption amount calculation information in respective operation states of respective devices. FIG. 11D shows an example of a power consumption amount calculation information table. A device ID 731 is used to uniquely identify a device to be managed by the power consumption management server 200. Power consumption amount 732 denotes a power consumption amount per unit time when the operation state of each device is a standby mode. Power consumption amount 733 denotes a power consumption amount per unit time in a power saving state such as a sleep mode. Power consumption amount 734 denotes a power consumption amount per unit time in a state during processing of a print job. Power consumption amount 735 denotes a power consumption amount per unit time in a state during processing of a scan job.

In this case, assume that this embodiment uses the same power consumption information as that in the state of the “during scan job processing” 735 when the image forming apparatus performs FAX transmission. Also, as for a job such as a copy job in which scan and print processes are executed at the same time, a combined value of that of the “during print job processing” 734 and that of the “during scan job processing” 735 is used as power consumption information.

Note that the respective pieces of table information shown in FIGS. 11A to 11D are not limited to those of this embodiment, and columns and rows of tables can be flexibly set in correspondence with device specifications.

A power consumption amount estimation module 1344 executes processing for estimating power consumption amounts of respective devices. However, the estimation processing is applied to an operation log received to have a measurement error attribute=1. This corresponds to, for example, a case in which a power consumption measurement unit of a device breaks down or it is detached. Also, this corresponds to a case in which a device which originally does not have any power consumption measurement mechanism transmits an operation log including a measurement error attribute=1 to the power consumption management server 200.

The power consumption amount estimation module 1344 analyzes an operation log including a measurement error attribute=1 (that is, that of a device in which a measurement error has occurred). The power consumption amount estimation module 1344 searches previous operation logs of devices, which are similar to the device corresponding to the operation log including the measurement error attribute=1, for an operation log which indicates an operation state similar to that of the operation log including the measurement error attribute=1 and includes a measurement error attribute=0 (no measurement error occurred) (search processing).

If such operation log is found, the power consumption amount estimation module 1344 executes processing for replacing power consumption amount information corresponding to the measurement error attribute=1 by that in an operation log ID corresponding to the measurement error attribute=0. In this case, the similar devices include not only those having the same device ID 701 in FIGS. 11A, 11C, and 11D, but also those which have the same model ID 703 in FIG. 11A and the same configurations of options 1 to 4 although the device ID 701 is different.

When the previous operation logs of the similar devices do not include any operation log which indicates a similar operation state and includes a measurement error attribute=0, the power consumption amount estimation module 1344 executes estimation calculation processing using the power consumption amount calculation correction information table shown in FIG. 11C and the power consumption amount calculation information table shown in FIG. 11D.

Note that the estimation calculation processing is executed using the following calculation formulas in case of, for example, a color print job. An operation processing time period is calculated from the end time 605 and start time 604 in the operation log information table shown in FIGS. 7A and 7B. The number of color-printed pages is specified by the color page count in FIG. 7A.

[Operation processing time period]=[end time]−[start time]

[Estimated power consumption amount]=[during print job processing 734]×[operation processing time period]+[print first page 722]+[color printing 723]×[number of color-printed pages]

An estimated power consumption amount calculated by the aforementioned calculations replaces power consumption amount information in the operation log information table.

In case of a monochrome print job, the estimation calculation processing is executed using the following calculation formula.

[Estimated power consumption amount]=[during print job processing 734]×[operation processing time period]+[print first page 722]+[monochrome printing 724]×[number of monochrome-printed pages]

In case of a scan job, the estimation calculation processing is executed using the following calculation formula.

[Estimated power consumption amount]=[during scan job processing 735]×[operation processing time period]+[scan 725]×[number of scanned pages]

In case of a standby mode which is not a state during job processing, the estimation calculation processing is executed using the following calculation formula.

[Estimated power consumption amount]=[standby mode 732]×[operation processing time period]

Likewise, in case of a sleep mode, the estimation calculation processing is executed using the following calculation formula.

[Estimated power consumption amount]=[sleep mode 733]×[operation processing time period]

Therefore, in the estimation calculation processing, when a device state corresponds to “during job processing”, the calculation formula is selected according to a job type (for example, a color print job, monochrome print job, or scan job). When a device state does not correspond to “during job processing”, the calculation formula is selected according to an operation mode (for example, a standby mode or sleep mode) of the device.

The aforementioned processing will be explained below using practical numerical values. Since the measurement error attribute=1 in the operation log IDs “1004” and “1005” in FIG. 7A, the power consumption amount estimation module 1344 executes the aforementioned processing. Since a device corresponding to the operation log ID “1005” including the measurement error attribute=1 is the image forming apparatus 100, the power consumption amount estimation module 1344 searches operation logs of similar devices, that is, the image forming apparatuses 100 and 101 for an operation log which indicates the same operation state “one color-printed page” and includes a measurement error attribute=0. In this case, an operation log ID “2003” in FIG. 7B indicates “one color-printed page” and includes a measurement error attribute=0, the power consumption amount information=0 Wh in the operation log ID “1005” in FIG. 7A is replaced (rewritten or corrected) by the power consumption amount information, that is, 500 Wh in the operation log ID “2003”.

Next, since a device corresponding to the operation log ID “1004” including the measurement error attribute=1 is the image forming apparatus 100, the power consumption amount estimation module 1344 searches operation logs of similar devices, that is, the image forming apparatuses 100 and 101 for an operation log which indicates the same operation state “three monochrome-printed pages” and includes a measurement error attribute=0. In this case, as shown in FIGS. 7A and 7B, since the power consumption amount estimation module 1344 cannot find any corresponding operation log, it executes the estimation calculation processing.

An operation processing time period of monochrome printing is calculated as 3 min ( 3/60 hour) according to the above formula. The number of monochrome-printed pages is 3 (pages). Hence, the estimated power consumption amount is calculated as:

[Estimated power consumption amount]=[during print job processing 734]×[operation processing time period (h)]+[print first page 722]+[monochrome printing 724]×[number of monochrome-printed pages]=1000× 3/60+2+1.5×3=56.5 (W/h)

The estimated power consumption amount=56.5 Wh obtained by the above calculation replaces 0 Wh as the power consumption amount information of the operation log ID “1004”. Note that a table to be replaced is a device operation log information table which has the same contents as those shown in FIGS. 7A and 7B, is obtained by the power consumption management server 200 from the image forming apparatus, and is managed by the device operation log information collection module 1342 in FIG. 10.

When, for example, the device configuration information table of respective devices shown in FIG. 11A has changed, the power consumption amount information in the power consumption amount calculation correction information table shown in FIG. 11C may change. At this time, an update time 702 at which, for example, the option configuration changed in practice, is compared with job start times in the operation log information table of the device operation log information collection module 1342. Then, when operation logs after the update time 702 include those including a measurement error attribute=1, the power consumption amount estimation processing is executed again.

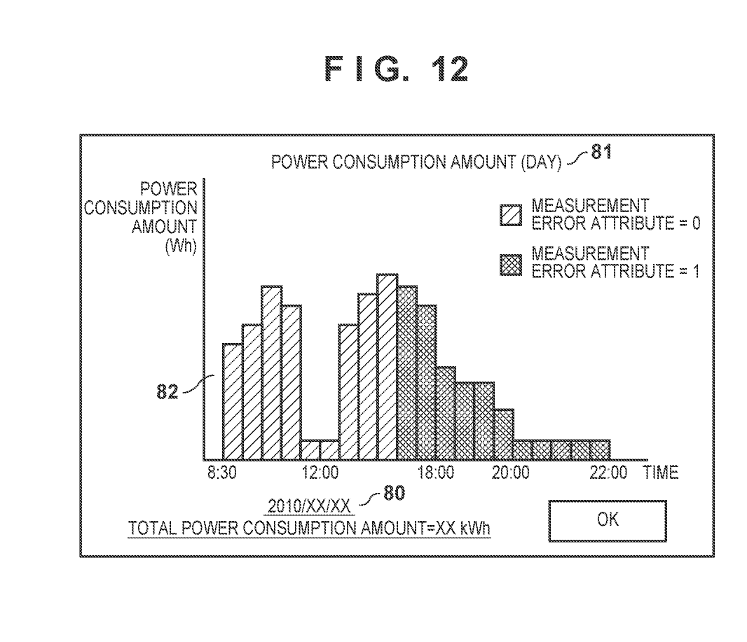

A power consumption amount display/generation module 1345 visualizes power consumption amount information of each device as a graph or the like, and displays it on a monitor such as the liquid crystal display of the operation unit 1306 via the interface module 1341. FIG. 12 shows a display example. In FIG. 12, hatched portions of bar graphs indicate information of actually measured power consumption amounts corresponding to a measurement error attribute=0, and cross-hatched portions of the bar graphs indicate information of power consumption amounts, which are estimated by the estimation calculation processing and correspond to a measurement error attribute=1.

This display processing is executed when an administrator who administrates the power consumption management server 200 operates the operation unit 1306, and displays power consumption amount information on, for example, the liquid crystal display. Title 81 denotes a title of the displayed contents. Since information of power consumption amounts per day is displayed as a graph, “power consumption amount (day)” is displayed as the title 81. Total power consumption amount 80 denotes a total power consumption amount during a displayed period. In a power consumption amount graph 82, power consumption amounts during a certain period are converted into a graph to be displayed upon reception of an instruction from the administrator. In this case, the ordinate plots a power consumption amount per unit time (Wh), and the ordinate plots a time.

This display processing is executed when a display request input by the administrator on the operation unit 1306 is supplied to the CPU 1301. More specifically, this display processing is implemented when the CPU 1301 executes the interface module 1341 and power consumption amount display/generation module 1345 in the aforementioned power consumption management program 1340.

In this embodiment, information is displayed on the liquid crystal display of the operation unit 1306. Alternatively, in response to a request from an external device such as the client PC 110 on the LAN 3000, information may be displayed on a display unit of the external device such as the client PC 110 via the network unit 1307.

<Operation Log Information Collection Sequence of Power Consumption Management Server>

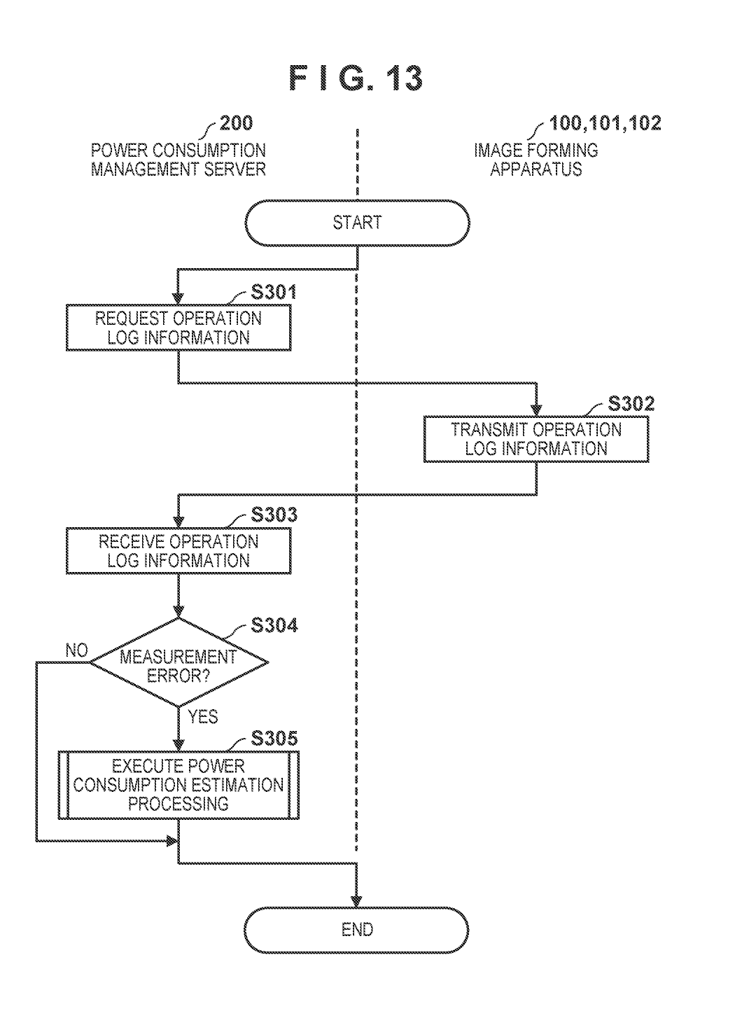

FIG. 13 is a flowchart showing the operations associated with collection of pieces of operation log information of respective devices, which operations are executed by the CPU 1301 of the power consumption management server 200. The respective devices indicate the image forming apparatuses 100, 101, and 102 in this embodiment.

In step S301, the CPU 1301 issues an operation log information request. More specifically, the CPU 1301 individually issues operation log information requests to the image forming apparatuses 100, 101, and 102 via the LAN 3000. Note that the CPU 1301 processes step S301 by executing the device operation log information collection module 1342 in the power consumption management program 1340.

Upon reception of the operation log information request in step S301, the CPU 1201 of each of the image forming apparatuses 100, 101, and 102 transmits operation log information via the network unit 1210 in step S302. The operation log information indicates information managed by the operation log information table shown in FIGS. 7A and 7B. Note that once each image forming apparatus transmits the operation log information, it transmits only difference information in response to the next and subsequent requests.

In step S303, the CPU 1301 in the power consumption management server 200 receives the operation log information of each image forming apparatus via the LAN 3000. The received operation log information is managed by a program in the device operation log information collection module 1342.

In step S304, the CPU 1301 conducts a search as to whether or not the operation log information tables obtained in step S303 include an operation log including a measurement error attribute=1. If no operation log including a measurement error attribute=1 is found, this flowchart ends; if an operation log including a measurement error attribute=1 is found, the process advances to step S305.

Then, in step S305, the CPU 1301 executes the power consumption amount estimation processing for the operation log including the measurement error attribute=1. Step S305 is processed when the CPU 1301 executes the power consumption amount estimation module 1344 in the power consumption management program 1340. Note that the detailed sequence of this step will be described later. After execution of step S305, the operation log information collection sequence ends.

<Power Consumption Amount Estimation Calculation Sequence of Power Consumption Management Server>

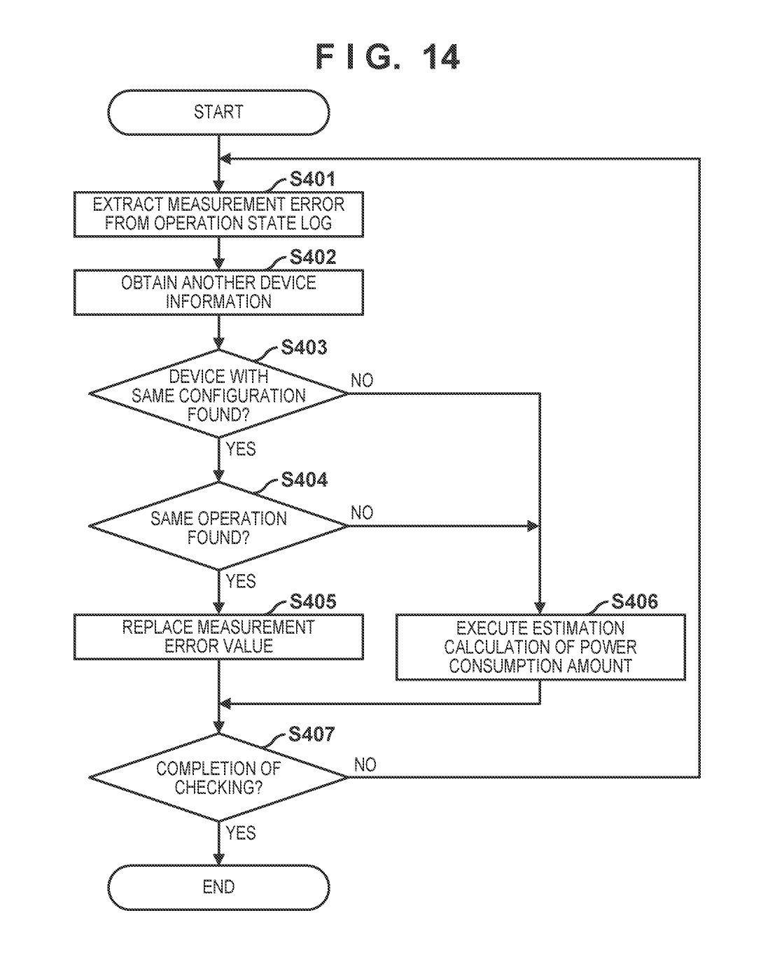

The power consumption estimation processing in step S305 in FIG. 13 will be described in detail below with reference to FIG. 14. In step S401, the CPU 1301 extracts operation logs each including a power consumption amount measurement error attribute=1 of a device found from the obtained operation state log tables of respective devices. Assume that, for example, the operation state log tables shown in FIGS. 7A and 7B are obtained from the image forming apparatuses 100 and 101. Then, assume that the operation log IDs “1004” and “1005” are extracted from the operation state log table of the image forming apparatus 100 as operation logs each including a measurement error attribute=1.

In step S402, the CPU 1301 obtains pieces of configuration information of all devices on the LAN 3000 as well as that of a device corresponding to the extracted operation logs each including the measurement error attribute=1. These pieces of information are obtained when the CPU 1301 refers to device configuration information managed by the device configuration information management module 1343 in the power consumption management program 1340. For example, assume that the pieces of information shown in FIGS. 11A to 11D are obtained.

In step S403, the CPU 1301 searches for a device having the same device configuration as that of an information log source corresponding to the power consumption amount measurement error attribute=1. Assume that this search is conducted based on the device configuration information obtained in step S402. In this example, a search is conducted for a device having the same device configuration as that of the image forming apparatus 100 corresponding to the measurement error attribute=1 within a management range of the power consumption management server 200.

As can be seen from FIG. 11A, the image forming apparatuses 100 and 101 have the same model ID and option configuration. Hence, in this case, the process advances to step S404. If no device having the same device configuration as that of an information log source corresponding to the power consumption amount measurement error attribute=1 is found, the process advances to step S406.

In step S404, the CPU 1301 then searches the operation state log information table of the device having the same configuration found in step S403 for the same operation state log information as that including the measurement error attribute=1. Note that this search is conducted for only operation logs each including a measurement error attribute=0 in the operation state log information table of the device having the same configuration. In FIG. 7A, in association with the operation log IDs “1004” and “1005”, the search is conducted for operation log IDs “1000” to “1003” of the image forming apparatus 100. Furthermore, the search is also conducted for the operation log information table of the image forming apparatus 101 as the device having the same configuration, that is, for operation log IDs “2000” to “2005”.

In this example, the same operation log is not found for the operation log ID “1004”, but the operation log ID “2003” is extracted for the operation log ID “1005” as the same operation log. As for “job” as an operation type, the same operation log is judged based on the operation type and pieces of information from the color page count 606 to the scan page count 608. As for “standby” or “sleep” as an operation type, the same operation log is judged based on information of an operation time period calculated by (end time)−(start time). However, assume that the administrator can freely set how to set this judgment criterion.

If the same operation log is extracted in step S404, the process advances to step S405. On the other hand, if the same operation log is not extracted, the process advances to step S406. In step S405, the CPU 1301 executes processing for replacing the power consumption amount information of the operation state including the measurement error attribute=1 by that of the same operation log extracted in step S404. Taking FIGS. 7A and 7B as an example, power consumption amount information=0 W of a print operation in the operation log ID “1005” is replaced by power consumption amount information=500 W in the operation log ID “2003”. Then, actually measured power consumption amount information having higher reliability than that calculated based on the estimation calculation formula can be used in replacement. Note that steps S405 and S406 are processed when the CPU 1301 executes the power consumption amount estimation module 1344 in the power consumption management program 1340.

In step S406, the CPU 1301 calculates power consumption amount information of the operation state including the measurement error attribute=1 by the estimation calculation processing. The power consumption amount information is calculated by estimation calculations based on the device configuration information, which is shown in FIGS. 11C and 11D and is obtained in step S402, and this processing is just the processing operation of the power consumption amount estimation module 1344 in the power consumption management program 1340.

The CPU 1301 determines in step S407 whether or not all pieces of operation state information are checked. If operation state information to be checked still remains, the process returns to step S401 to continuously execute the power consumption amount estimation calculation sequence. If all pieces of operation state information have been checked, the power consumption amount estimation calculation sequence ends.

<Estimated Power Consumption Amount Update Sequence of Power Consumption Management Server>

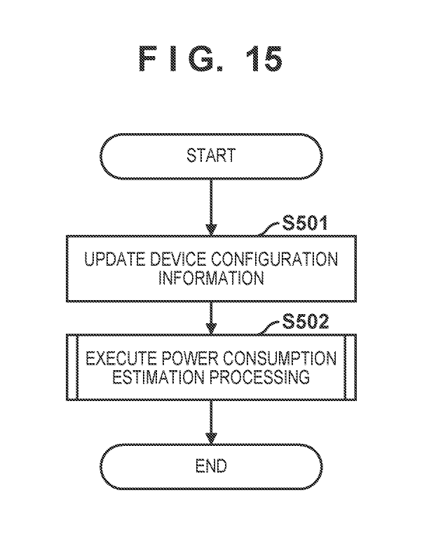

When the device configuration information table of respective devices shown in FIG. 11A changed, power consumption amount information in the power consumption amount calculation correction information table shown in FIG. 11C may often change. FIG. 15 shows the operation sequence at that time.

In step S501, the CPU 1301 updates device configuration information upon reception of a data input from the administrator of the power consumption management server 200. For example, this is the case when a paper discharge unit Y is attached to the image forming apparatus 100 as an option. Furthermore, this is also the case when the estimated value of the power consumption amount corresponding to operation processing of each device shown in FIG. 11C is updated to a more precise value.

Note that a change of device configuration information may be received from each device via the LAN 3000, and the CPU 1301 may automatically rewrite the configuration information without the intervention of the administrator. When such change is executed, the update time 702 is appropriately changed.

Next, in step S502, the CPU 1301 executes power consumption estimation processing. This is to re-execute the power consumption amount estimation calculation sequence shown in FIG. 14. However, at this time, the CPU 1301 refers to the update time 702 in the device configuration information table shown in FIG. 11A, and executes re-processing only for operation log information (operation log ID) including a measurement error attribute=1 after this update time. In this way, the estimated value of the power consumption amount in the operation log information including a measurement error attribute=1 can always be maintained as a value with high reliability.

<Power Consumption Amount Display Processing>

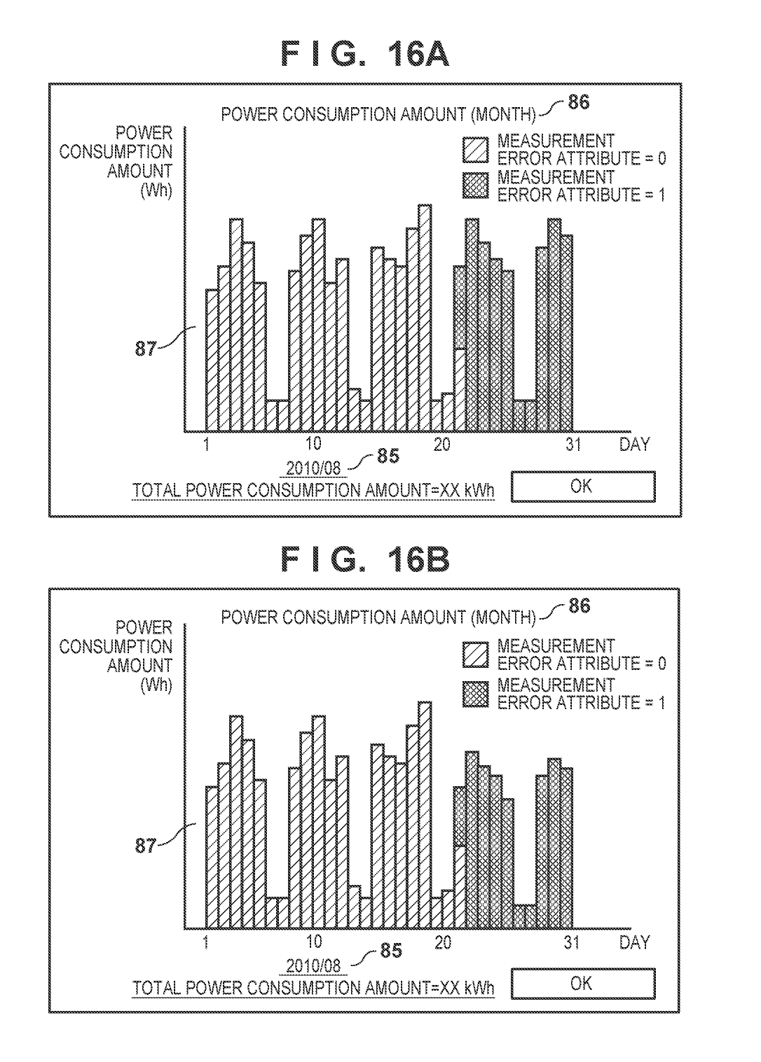

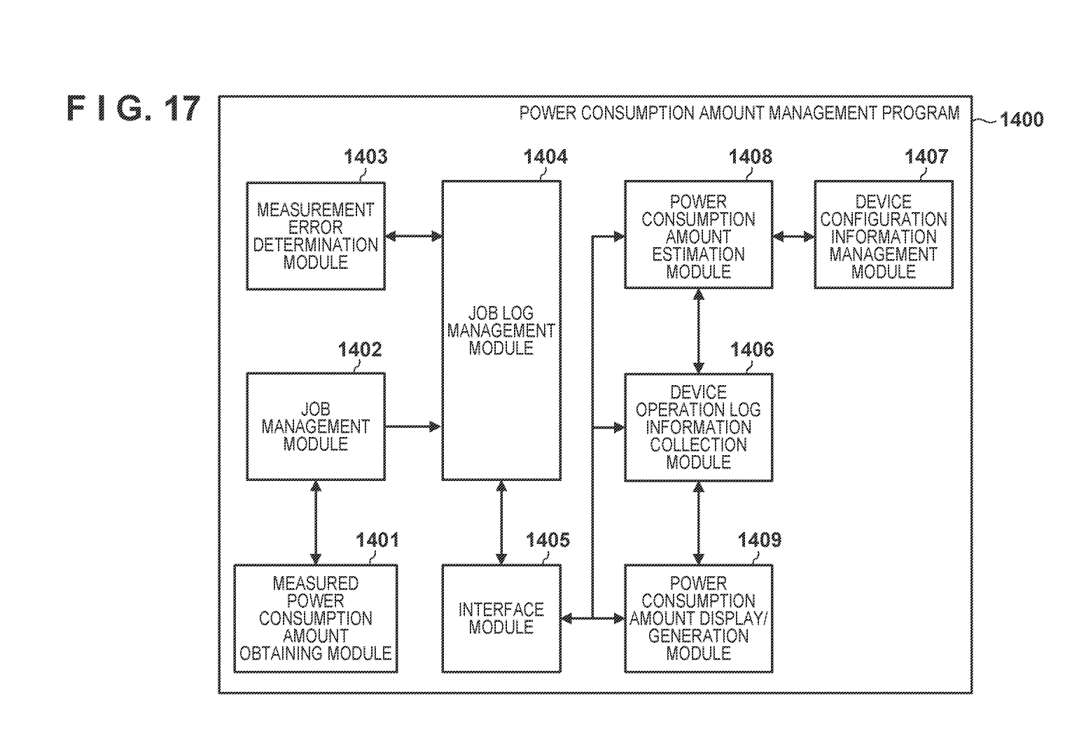

FIGS. 16A and 16B show graphs showing a change of displayed power consumption amounts based on the estimated power consumption amount update sequence shown in FIG. 15. As in FIG. 12, each of these graphs is displayed on the monitor such as the liquid crystal display of the operation unit 1306 via the interface module 1341 when the CPU 1301 executes the power consumption amount display/generation module 1345 in the power consumption management program 1340.

Referring to FIG. 16A, title 86 denotes a title of displayed contents. In FIG. 16A, since pieces of information of power consumption amounts per month are displayed as a graph, “power consumption amount (month)” is displayed in a column of the title 86. Total power consumption amount 85 denotes a total power consumption amount during a displayed period, and a total power consumption amount of August, 2010 is displayed in this case. In a power consumption amount graph 87, power consumption amounts per month are displayed as a graph upon reception of an instruction from the administrator. In this case, the ordinate plots a power consumption amount per unit time, and the abscissa plots days (1st to 31st days).

Hatched portions of bar graphs indicate information of actually measured power consumption amounts corresponding to a measurement error attribute=0, and cross-hatched portions of the bar graphs indicate information of power consumption amounts based on the estimation calculation processing corresponding to a measurement error attribute=1. As can be seen from FIG. 16A, displayed power consumption amounts are switched to those based on the estimation calculation processing corresponding to a measurement error attribute=1 due to an arbitrary cause such as a failure of the power measurement unit since the 22nd day.

In this state, when the device configuration information table of respective devices shown in FIG. 11A is changed in September, 2010, the graph changes, as shown in FIG. 16B. At this time, for example, this corresponds to, for example, a case in which the update time 702 in FIG. 11A was Aug. 20, 2010. That is, this corresponds to, for example, a case in which the option configuration was changed on Aug. 20, 2010, and the power consumption management server recognized that change in September, 2010.

The same applies to a case in which the estimated values of power consumption amounts for operation processes of respective devices shown in FIG. 11C are updated to more precise values. FIG. 16B shows a change in graph at that time. FIG. 16B is basically the same as FIG. 16A, but amounts of the cross-hatched portions of the bar graphs are changed. This indicates that pieces of information of power consumption amounts based on the estimation calculation processing corresponding to a measurement error attribute=1 have been changed to more reliable values. Thus, the administrator of the power consumption management server 200 can always obtain information of highly reliable power consumption amounts based on the estimation calculation processing even when a power consumption amount measurement error has occurred.

### Second Embodiment

The second embodiment required to carry out the present invention will be described hereinafter. The second embodiment will exemplify a case in which the power consumption amount management program implemented by the power consumption management server 200 in the first embodiment is implemented in an image forming apparatus. By adopting such configuration, the same functions can be implemented by an image forming apparatus alone.

In order to implement the power consumption management function in the image forming apparatus, the power consumption amount management program shown in FIG. 10 is recorded and held in the HDD 1204 or RAM 1202 of the image forming apparatus, and is executed by the CPU 1201. The displayed contents shown in FIG. 12 and FIGS. 16A and 16B are displayed on a screen (the liquid crystal operation panel 11 shown in FIG. 4) of the operation unit 10 included in the image forming apparatus, or inputs are accepted on the screen of the operation unit 10.

The image forming apparatus including the power consumption management function can manage power consumption amounts of not only the self apparatus but also those of a plurality of other image forming apparatuses, and can execute the power consumption management function by inputting and displaying required data from the operation unit 10. This embodiment will be described in detail below in association with differences from the first embodiment with reference to the drawing.

<Hardware Arrangement of Image Forming Apparatus>

The hardware arrangement of the image forming apparatuses 100, 101, and 102 in the second embodiment is the same as that of the contents described in FIG. 2 of the first embodiment. The arrangements of the operation unit shown in FIG. 3 and the power measurement unit shown in FIG. 4 are also the same. The image forming apparatus of the second embodiment has different contents of the power consumption amount management program from those of the first embodiment.

<Power Consumption Amount Management Control of Image Forming Apparatus>

A power consumption amount management program 1400 of each image forming apparatus according to the second embodiment will be described below with reference to FIG. 17.

In FIG. 17, a measured power consumption amount obtaining module 1401 to job log management module 1404 in the power consumption amount management program 1400 have the same functions as those of the blocks 1291 to 1294 having the same names in the first embodiment. An interface module 1405 has combined functions of the interface module 1295 of the first embodiment, and the interface module 1341 of the power consumption management server 200 of the first embodiment.

A device operation log information collection module 1406 to power consumption amount display/generation module 1409 have the same functions as the device operation log information collection module 1342 to power consumption amount display/generation module 1345 of the power consumption management server 200 of the first embodiment. A display function in the power consumption amount management program 1400 displays all pieces of information on the screen (the liquid crystal operation panel 11 shown in FIG. 4) of the operation unit 10 in the image forming apparatus, as described above.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-025340, filed Feb. 8, 2011, which is hereby incorporated by reference herein in its entirety.

What is claimed is:

1. A system for obtaining a power consumption amount of a device and managing the obtained power consumption amount, the system comprising:
an obtaining unit configured to obtain a power consumption amount of the device by a power meter;
an estimation unit configured to estimate the power consumption amount of the device based on a executed job log; and
a management unit configured to, when said obtaining unit normally obtains the power consumption amount of the device, manage the obtained consumption amount of device, and when said obtaining unit does not normally obtain the power consumption amount of the device, manage the power consumption amount estimated by said estimation unit.

2. The system according to claim 1, further comprising:
a determination unit configured to determine whether or not said obtaining unit normally obtains the power consumption amount of the device; and
a notification unit configured to notifies the management apparatus of information which associates the power consumption amount obtained by said obtaining unit and the determination result of said determination unit with each other.

3. The system according to claim 2, wherein the device is an image forming apparatus, and
said notification unit notifies the management apparatus of job log information in the image forming apparatus.

4. The system according to claim 1, further comprising a display unit configured to display the power consumption amount obtained by said obtaining unit or the power consumption amount estimated by said estimation unit.

5. The system according to claim 4, wherein said display unit distinguishably displays the power consumption amount received by a reception unit and the power consumption amount estimated by said correction unit.

6. The system according to claim 1, wherein said estimation unit estimates a power consumption amount associated with a determination result indicating that the power consumption amount of the device was not normally obtained.

7. The system according to claim 1, wherein said estimation unit estimates the power consumption amount according to a type of a job when the device is in job processing, and estimates the power consumption according to an operation mode of the device when the device is not in job processing.
